(19) United States
(12) Patent Application Publication
(10) Pub. No.: US 2008/0289584 A1
(43) Pub. Date: Nov. 27, 2008

(54) Rechargeable Herbal Containing Fabric Products for Domestic Animals

(76) Inventor: Debi Fay, Denver, CO (US)

Correspondence Address: Leyendecker & Lemire, LLC, C/O PORTFOLIO IP, P.O. BOX 52050, MINNEAPOLIS, MN, 55402, US

(21) Appl. No.: 11/752,592

(22) Filed: May 23, 2007

(51) Int. Cl. A01K 29/00; A01K 27/00; B05B 11/00; B68C 5/00

(52) U.S. Cl. 119/712; 119/709; 119/856; 222/251; 54/79.1

(57) ABSTRACT

Pet products including pet collars, rope bones, blankets, harnesses and pet wraps are described that are charged with an herbal extract/essence. The pet product typically includes a fabric portion, such as fleece, intended to hold the herbal extract/essence therein. The pet products can be packaged in combination with an herbal solution along with instructions to periodically recharge the pet product with the herbal extract/essence.

### FIELD OF THE INVENTION

This invention generally relates to fabric products, such as chew toys, blankets and collars, for use by domesticated animals.

### BACKGROUND

According to recent statistics there are over 375 million pets in the United States alone. And like people, pets can suffer from a myriad of physical and psychological problems. The psychological issues of their pets can be extremely frustrating to owners. For example, a dog suffering from separation anxiety might chew shoes or other items, scratch at the walls or doors and/or bark incessantly. A cat, males in particular, may repeatedly mark locations in its home to protest or indicate dissatisfaction with a situation in the home.

Behavioral issues are generally dealt with in a variety of ways. Owners may attempt to change the animal's surroundings such as confining the animal when the owners are not around; however, while this may minimize the damage an animal is causing, it often does nothing to allay the cause of the animal's psychosis. Training may be utilized to combat the behavior; however, depending on the personality of the animal and the skill of the trainer, this may not be effective. Drugs may be utilized in more severe instances when the above solutions have not worked; however, drugs can be expensive, difficult to administer and change the personality of the animal. Finally, an owner may get rid of the animal.

Various research has shown that certain herbal extracts/essences and combinations of herbal extracts/essences when ingested or placed in proximity to an animal, such as in aroma therapy, have beneficial therapeutic affects on the animal. One of the most significant issues pertaining to the use of herbal therapy is getting an animal to digest or remain in very close proximity to the herbal extracts/essences. It is often very difficult to get animals to chew tablets or ingest pills. Liquid drops can be placed on food, but this requires the animal's caretaker to remember to add the drops on a regular basis and there always is the risk that the animal does not eat the food in which much of the herbs have been absorbed. Even worse, the liquid may never be ingested because it drips to the bottom of a bowl and/or the food in which the drops are absorbed becomes unpalatable to the animal.

The relevant prior art describes various types of animal toys that are impregnated or infused with various substances beneficial to an animal's health. For instance rawhide chews impregnated with substances that promote periodontal health are known. Molded chews comprised of herb, vitamin and mineral impregnated resins are also known. All of these products suffer from a limited useful lifespan. For instance, rawhide chews may last only a day or so depending on the size of the dog in relation to the size of the chew. At least one company produces a rope bone that incorporates wintergreen or spearmint dental floss therein. However, the spearmint or wintergreen flavoring presumably of the floss is likely not natural but man made. Further, the flavoring is likely to have an only limited lifespan as the product is chewed.

Another manner in which herbs can be utilized in relation to domestic animals is through aromatherapy. Research on animals and humans suggest that certain smells can positively or negatively affect behavior. Accordingly, by providing an animal with certain and specific aroma, the tendency to partake in undesirable behaviors may be reduced. Very few aromatherapy products other than spritzers, powders and sprays are available for animals. One product that is available is a stuffed fabric toy that includes a pouch in which aroma disks are placed. As can be appreciated the disks have to be periodically replaced. This product is produced and sold for cats since cats are unlikely to destructively chew such a product but rather primarily bat it around. This product would not be suitable for dogs that would likely rip the product open and possibly digest the flavor disk. Depending on the concentration of herbs and other materials in the disks, this could cause a dog to become ill.

### BRIEF DESCRIPTION OF THE DRAWINGS

FIG. 1 is an isometric view of a fleece rope dog chew toy according to one embodiment of the present invention.

FIG. 2 is an isometric view of a fleece pet blanket according to one embodiment of the present invention FIG. 3 is an isometric view of a dog collar and incorporating a fleece insert according to one embodiment of the present invention.

FIG. 4 is an isometric view of a fleece robe dog chew toy and its associated herbal infusion as packaged for sale according to one embodiment of the present invention.

### DETAILED DESCRIPTION

Embodiments of the present invention comprise goods incorporating fabric that has been charged with a combination of one or more herbs. The goods/products can include pet chew toys, pet blankets, pet collars, pet harnesses and pet wraps. The herbal solution applied to the good can comprise a single herb or a combination of herbs. The particular combination of herbs may depend on particular or desired result relative to a pet.

In some embodiments, the fabric materials comprise man-made polyester fleece (herafter referred to just as “fleece”). The material is generally a napped pile fabric originally intended for wool replacement applications because of its very good insulating properties. The product was introduced originally by Malden Mills of Lawrence, Mass. and was made of Polyethylene terephthalate (commonly referred to as PET) from the polyester family. The material is available in various thicknesses depending on the desired insulating capabilities contrasted with the desired flexibility of the fabric.

For use in the aforementioned pet products, thicker varieties of fleece having high nap densities and longer naps are most desirable but some of the less dense and thinner variations may be acceptable in certain embodiments. Fleece is generally soft and non-abrasive on teeth yet the relatively long naps facilitate the cleaning of plaque off a pet's teeth. Fleece does not easily pill and can withstand repeated machine washings and dryings. It also resists staining. Additionally, the napped material provides many locations and areas below the top surface of the fabric to hold the essences/extracts of herbs such that they cannot be easily rubbed off as easily as with many other fabrics.

Several embodiments comprise a fabric pet product (collar/blanket/chew toy/harness or other), typically comprised of fleece, provided in combination with a herbal solution and instructions for re-charging the good periodically to ensure the product maintains its effectiveness unlike many infused or charged prior art pet products. The herbal solutions may also be independently sold and marketed as replacements once the solution provided with the fleece good is fully used. Furthermore, a pet owner may purchase a second herbal solution relative to therapeutically treat his/her pet for a condition different from the condition treated with the solution that was packaged with the pet product.

Embodiments further describe the manner of re-charging the fabric pet products. Typically, every two weeks or as needed, the user can spray the product with the provided herbal solution thereby renewing the herbal essences/extracts resident on the product.

Advantageously, the effective lives of the embodiments for treating a particular condition are extended over prior art pet products through the re-charging of the products. The foregoing embodiments further present a more economical solution to pet behavioral problems than having to repeatedly buy replacement goods that expect for decline in the potency of the herbs contained thereon is still usable.

The herbal pet wraps are typically comprised of a cotton terry cloth material that does not dry as quickly as fleece. In use, an herbal solution poured on the wrap or the wrap is dipped in an herbal solution. Next, the herbal containing wraps are placed against the pet's fur/skin to treat a condition, such as bites, stings, cuts or fungal infections. Embodiments of the wrap would be sold with a separate container of herbal solution formulated for a specific use, such as treating insect bites, and the solution would be absorbed into the wrap just before use. In such embodiments the product would be packaged as one or more wraps, an container of herbal solution and instructions for the use of the wrap. The wrap itself may be provided dry or it may also be packaged in a sealed packet with herbal solution already absorbed thereon.

### Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variations” and similar phrases mean that a particular feature, structure, or characteristic described in connection with the embodiment is included in at least an embodiment of the invention. The appearance of the phrase “in one embodiment” in various places in the specification are all not necessarily meant to refer to the same embodiment.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

As used herein, the term “fleece” refers to a napped fabric commonly referred to as “polar fleece” that is comprised of a synthetic polymeric material and typically polyester.

### Embodiments of Pet Products

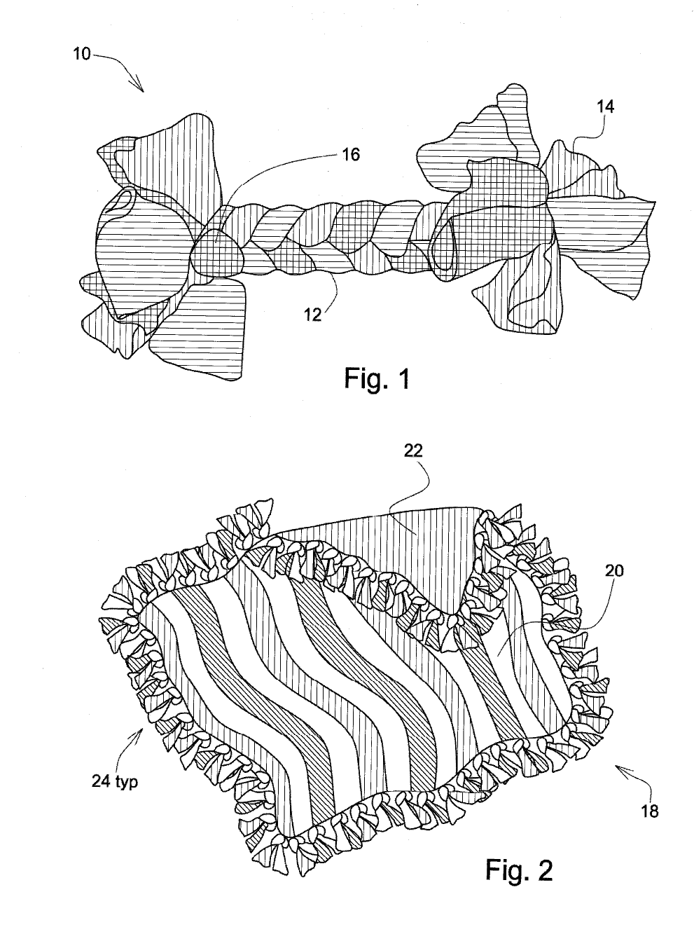

FIGS. 1-3 illustrate several pet products that are typically charged with a suitable combination of herbal extracts/essences. The herbs and herbal solutions are discussed in greater detail below. FIG. 1 illustrates what is commonly referred to as a rope bone 10. The rope bone comprises a plurality of strips 14 of fabric that are braided together to form a center portion 12 with the ends of each strip extending and splaying from one of two opposing end knots 16.

FIG. 2 illustrates a fabric pet blanket. The blanket 18 is typically comprised of front and back plies 20 & 22 of fabric, most typically fleece, that are joined together at least at the perimeter edge of the blanket. By using two plies, the front and back surfaces of the blanket can be made of two differing colors or patterns. In the illustrated variation the front comprises a stripe pattern while the backside comprises a solid color. The colors may be chosen based on research pertaining to the effect different colors have on particular types of animals. A single ply blanket is also contemplated.

The edges of the blanket may be hemmed to present a smooth edge that is resistant to fraying or, as illustrated, the edges of the blanket can comprises a plurality of knots distributed along one or more sides of the blanket with strips of fabric 24 extending outwardly from each knot to create fringed sides. The strips and knots can provide an area of interest for dogs to chew on and for cats to swat. Further, the knots help hold additional herbal extracts/essences therein.

The knotted ends can be separately manufactured and then sewn or otherwise secured to the edges of a blanket or they can be integrally fabricated with the one or more plies of the blanket. For instance, the edges of the plies can be slit generally perpendicularly inwardly from their peripheral edges at regular spacings and then groupings of the various strip created by the slitting can be tied together to form a knot. As illustrated, all four sides are fringed but in variations less than all four sides may be fringed. For instance, two opposing sides may be fringed and the other two opposing sides may have smooth edges.

FIG. 3 is an illustration of a pet collar 26 incorporating a fabric, most preferably a fleece fabric, on either or both the front and rear faces of the collar strap. In one variation, the collar comprises buckle ends 28&30 coupled with a strap member 32 that is typically length adjustable. The strap is comprised of a relatively high strength woven fabric first layer and a fleece second layer 34. As illustrated, the first layer is wider than the second layer and is accordingly wrapped over the front side of the second layer thereby hemming in the edges of the fleece layer. Either of the first and second layers can comprise the front or backside of the collar. In a variation of the collar, the front and back plies can comprise a fleece insert wherein the collar further includes a center ply of a high strength fabric and wherein the various plies are interconnected perhaps by way of hemmed edges. In yet another variation, the front and back plies comprise a fleece material with the longitudinal edges of the plies being hemmed together with a high strength fabric such as nylon. Further, any number of suitable variations are contemplated that incorporate a fleece insert as would be obvious to one of ordinary skill given the benefit of this disclosure.

Although not specifically illustrated, a harness, such as for a horse, can also be fabricated that includes a fabric material adapted to receive an herbal essence/extract thereon. The fabric in certain embodiments also comprises a fleece material. The herbal essences/extracts containing fabric of the harness can be either outwardly facing or inwardly facing, such as placed up against the fur of the animal.

As mentioned above, the fabric material of each product, which typically comprises fleece, is infused with herbal essences/extracts typically from an herbal solution prior to retail sale. Typically, the products are completely immersed in a liquid herbal solution, such as may be contained in a drum or vat, for a sufficient time for the solution to completely permeate and saturate the fabric. Next, the fabric is removed from the solution, possibly wringed or squeezed to remove excess solution, and then dried typically, but not necessarily, in a low-heat dryer. The resulting product is subsequently packaged for sale.

Another product that is not specifically illustrated includes a pet wrap which in some embodiments comprises a piece of terry cloth fabric tape that can be wrapped around an appendage or body of a pet. Unlike the other products, the wrap is intended for use when wet with an herbal solution. So in embodiments wherein the wrap is provided in a pre-saturated condition, it is typically packaged in a sealed pouch or other container that prevents evaporation of the solution and also maintains the sterility of the wrap. In other variations, the wrap is provided dry for application of the solution immediately prior to application of the wrap to a pet.

### Embodiments as Packaged For Retail Sale

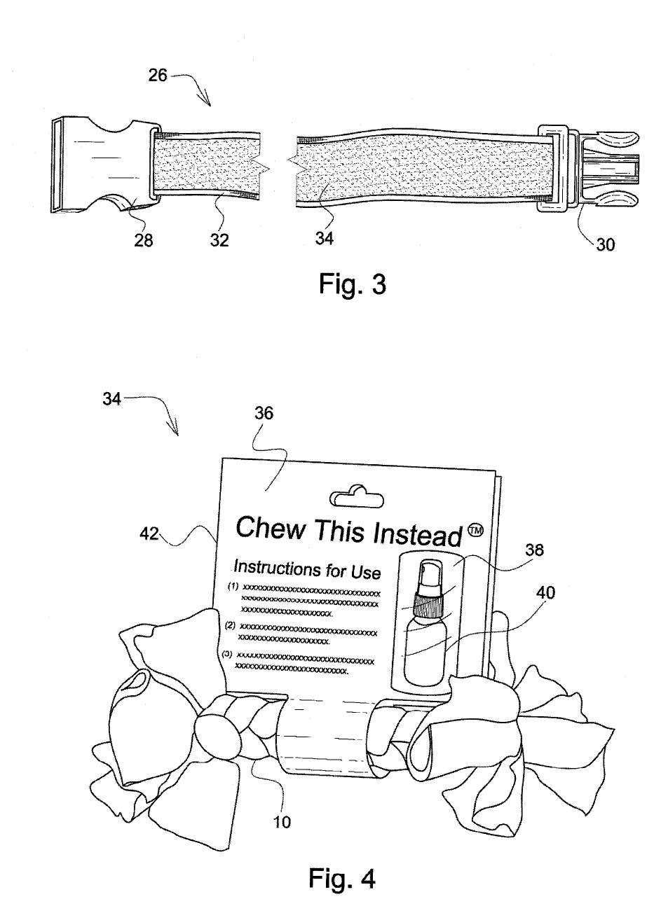

FIG. 4 is an illustration of a rope bone 10 as described above packaged for retail sale with a bottle of herbal solution 40 and instructions 42 for using the herbal solution to recharge the rope bone. Combinations including the pet product, the herbal solution and usage instructions all packaged together are contemplated for the blanket and collar as well.

As illustrated, the packaging 36 comprises a folded over hang card, typically fabricated from cardboard or a plastic material, that supports the rope bone 10 and includes a cutout for hanging the package on a retail hook. A cutout is provided in which clear plastic blister packaging or similar encloses the herbal solution.

The herbal solution, as illustrated, is provided in a 1-2 ounce bottle with a spray top. The solution is typically provided at its appropriate use concentration. The bottle may be colored as to minimize the passage of light through the solution as certain wavelengths of light can over time act to degrade the solution. In one variation, the bottle is a dark amber color. In another variation, the herbal solution may comprise a concentrate and the bottle may include an eye dropper type top. In using this variation, the user may place the specified number of drops in a spray bottle and fill the remainder with water to create a solution of desired strength to be sprayed on the pet product. As an alternative to spraying, the user may put a predetermined number of drops into a pail or sink basin filled with water in which the pet product is subsequently soaked.

As can be appreciated many variations in packaging are possible depending on the particular pet product, the herbal solution and the methodology of applying the herbal solution. Nevertheless, in at least some embodiments of the packaged product, the combination includes the pet product, an herbal solution and instructions for applying the solution to the pet product to periodically recharge it.

### Herbal Solutions

Solutions for the essence/extract of any particular herb vary in type and concentration often depending on the herb. Some of the types of herbal solutions include, but are not necessarily limited to: essential oils; hydrosols; and tinctures. In their base form, the solutions for any particular herb may be very concentrated and are created in anyone from a variety of methods known in the art. The actual method used can often depend on the particular herb. Some of the types of herbal essences/extracts include tinctures, essential oils and hydrosols. Tinctures are produced by seeping an herb or flower in alcohol. Essential oils can be produced from a number of methods including expression, distillation and solvent expression. Hydrosols typically comprise water byproducts from the steam distillation of an herb to obtain essential oils.

The base extracts or essences of various herbs is usually highly concentrated and can typically be purchased through a variety of sources. To produce an herbal solution for use with the various pet products, various extracts and/or essences are combined depending on the particular behavior/condition to be addressed and are also diluted typically with distilled water.

For a dog suffering from separation anxiety an herbal solution comprising Valerian Root, Sweet Basil, Passion Flower and Skull Cap that is diluted with distilled water may be provided for use with a rope bone.

For promoting dental hygiene in a dog, an antibacterial solution of 0.3% Chlorhexidine rinse may be combined with essential oils of Sage, Cardamom and Coriander Seed and diluted with distilled water.

For use with a pet blanket for treating a pet for senility, an aromatic blend of Olive, Chamomile, Valerian Root and Lavender can be combined with distilled water. Typically, on pet blankets the aroma of the herbs given off from the blanket provide the therapeutic benefits in contrast to the rope bone wherein the benefits are primarily obtained through the pet chewing on and accordingly ingesting the herbal extracts.

For use with a pet blanket for treating a pet for obsessive compulsive disorder, a combination of essences/extracts of Impatiens, Chestnut Bud, Beech, and Valerian Root may be mixed with distilled water.

Similar combinations intended for the blanket and an aroma therapy application can also be used with embodiments of the pet collar and the harness although the concentration of the herbal essences/extracts in the herbal solution may be increased to account for the reduced surface area of the collar.

A typical concentration of each herbal extract/essence is about 2 drops per 8 ounces for essential oils, hydrosols and tinctures that are dispensed via an eyedropper or a concentration of about 1-2% dilution. The actual concentrations can vary substantially and significantly depending on the particular combination and the problem or condition the herbal solution is configured to address. Further, the combinations of herbal extracts and essences provided herein are merely exemplary and not intended to limit the range of combinations of various herbal extracts and essences that can be used in different combinations to treat pet conditions and disorders.

### A Method of Re-Charging the Pet Product Using the Herbal Solution

Embodiments of the various pet products are initially charged or loaded with herbal essences and extracts and accordingly come ready to use when purchased. To initially prepare the product, it can be soaked until completely liquid saturated in a container full of a distilled water herbal solution. The products are then dried by any suitable means including air drying and drying in a low heat dryer so as not to degrade the herbal extracts and essences as the water is evaporated. The product is then packaged for sale. In some embodiments as discussed above, packaging may also include an herbal solution to recharge the product along with instructions on how to recharge the product using the included solution.

In embodiments, one method to recharge the pet product comprises spraying the surface of the intended fabric portion, often comprising fleece, with the herbal solution that was provided in the associated packaging until the fabric is lightly damp. Next, the user waits until the fabric is dry until providing the product to his/her pet. Typically, a pet product will need to be charged every 2 weeks or so of normal use; however, the product should be charged after each washing and may need to be charged more often depending on use and the conditions to which the product is exposed.

Concerning the herbal wraps, the herbal solution can be applied to the wrap in a similar manner as described above or in other instances a portion or the entire contents of a container may be poured onto the wrap (or a select section of the wrap). Rather, than permit the wrap to dry, it is typically applied to the pet in its wet condition.

Typically, the instructions will recite variations on the foregoing methodology and information concerning the frequency of recharging; however, the other instructions may be provided in other embodiments as is applicable concerning an herbal solution and it packaging. For instance, in one variation the herbal solution may be less dilute than described above and may be provided in a bottle having an eyedropper type dispenser in which the instructions recite a methodology for diluting the solution in a container of water and immersing the product in the water to recharge the product. In yet another possible variation, the solution may come in a dropper bottle with instructions to add the solution in a predetermined proportion to water in a spray bottle for subsequent spray application onto a product. Other possible means for dispensing the herbal solution and recharging the product are contemplated as would be obvious to one of ordinary skill given the benefit of this disclosure. Further, instructions pertaining to any particular methodology for preparing the herbal solution and recharging the pet product are also contemplated.

### Other Embodiments and Variations

The various preferred embodiments and variations thereof illustrated in the accompanying figures and/or described above are merely exemplary and are not intended to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

I claim:

1. A pet product comprising:
a fleece fabric; and
an herbal extract/essence resident within and on the fleece fabric.

2. The pet product of claim 1, wherein the pet product comprises a chew toy.

3. The pet product of claim 1, wherein the pet product comprises a blanket.

4. The pet product of claim 1, wherein the pet product comprises one of a pet collar and a pet harness.

5. The pet product of claim 1, wherein the herbal extract/essence comprises extracts and essences of at least two herbs.

6. A combination of the pet product of claim 1, (i) an herbal solution, (ii) instructions pertaining to the charging of the pet product with herbal extracts/essences and (iii) associated packaging.

7. The combination of claim 6, wherein indicia on the package indicates a behavior condition of a pet that the enclosed herbal solution is formulated to treat.

8. The combination of claim 6, wherein the solution is contained in a spray bottle.

9. The combination of claim 8, wherein the spray bottle is comprised of a darkly colored glass or plastic.

10. The combination of claim 8, wherein the instructions direct a user to spray the herbal solution onto the surface of the fleece using the spray bottle to recharge the pet product.

11. The combination of claim 8, wherein the herbal solution comprises the extracts/essences of one of the following herbal combinations: (i) Valerian Root, Sweet Basil, Passion Flower and Skull Cap; (ii) an antibacterial solution of 0.3% Chlorhexidine, Sage, Cardamom and Coriander Seed; and (iii) Impatiens, Chestnut Bud, Beech, and Valerian Root.

12. The combination of claim 11, wherein each of the extracts/essences of anyone one of the herbal combinations is diluted in distilled water to a concentration of about 1%-2% by volume.

13. The combination of claim 8, wherein the instructions direct a user to spray the pet product with the herbal solution using the spray bottle on a periodic basis.

14. A method of charging the pet product of claim 1, the method comprising:
wetting the fleece fabric with an herbal solution comprising the extracts/essences of one or more herbs diluted in water; and
permitting the fleece fabric to dry before providing the pet product to a pet.

15. The method of claim 14, wherein said wetting the fleece fabric further comprises spraying the solution onto the fleece fabric using a spray bottle.

16. A combination for retail sale, the combination comprising:
a pet product comprised at least partially of a fabric material;
an herbal solution containing the extracts/essences of one or more herbs;
instructions including indicia for charging the pet product with the extracts/essences.

17. The combination of claim 16, wherein fabric material includes herbal extracts/essences resident thereon.

18. The combination of claim 16, wherein the pet product comprises a fabric pet wrap.

19. A method of charging a pet product having a fabric portion with therapeutic extracts/essences of one or more herbs resident thereon, the method comprising:
first, providing a pet suffering from a behavior condition with the pet product; and
next, re-charging the fabric portion with the extracts/essences of one or more herbs by applying an herbal solution to the fabric portion.

20. The method of claim 19, further comprising: washing the pet product and choosing a particular herbal solution based on the pet's behavioral or physical condition, both prior to said re-charging.
